(19) United States
(12) Patent Application Publication
(10) Pub. No.: US 2025/0335674 A1
(43) Pub. Date: Oct. 30, 2025

(54) DRAWING CREATION SUPPORT SYSTEM

(71) Applicant: Semiconductor Energy Laboratory Co., Ltd., Atsugi-shi (JP)

(72) Inventors: Kengo AKIMOTO, Isehara (JP); Junpei MOMO, Sagamihara (JP); Hidekazu MIYAIRI, Hadano (JP)

(21) Appl. No.: 19/169,066

(22) Filed: Apr. 3, 2025

(30) Foreign Application Priority Data
Apr. 24, 2024 (JP) 2024-070347

(51) Int. Cl. G06F 30/31; G06F 30/392; G06F 30/398

(52) U.S. Cl. CPC G06F 30/31; G06F 30/392; G06F 30/398

(57) ABSTRACT

One embodiment of the present invention is to provide an information processing system enabling a user to obtain a drawing the user needs. For assisting the user in creating a drawing for a patent application, a drawing creation support system is built, in which the enlargement of a drawing, addition of hatching patterns, selection of the hatching patterns are performed with a generative AI model and a magnifying power for optimizing a hatching line spacing is calculated by the generative AI model.

### BACKGROUND OF THE INVENTION

### 1. Field of the Invention

One embodiment of the present invention relates to an information processing system and an information processing method.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Specific examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

In recent years, language models using artificial neural networks have been actively developed, and especially large language models (LLM) have attracted attention. A LLM is a natural language processing model learned using a large amount of data. A LLM enables, for example, a conversational model for responding to user's instructions. In Non-Patent Document 1, generative pre-trained transformer 4 (GPT-4, registered trademark) is disclosed as a LLM, and ChatGPT is disclosed as a conversational model.

### REFERENCE

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

To produce engineering products, the product layout design and the product process are determined, and the process conditions are adjusted. In addition, to protect the engineering products, a patent application relating to the engineering products is required to be filed, through preparation of necessary drawings, in a short time.

When the engineering product has a relatively simple structure, in many cases, it does not take a long time to create drawings for the patent application. For example, the top surface or the side surface of the engineering product is captured, and an image thereof is taken with a camera. The drawing based on the image can be created for the patent application. Furthermore, a blueprint based on the drafting method, which has been used in producing the engineering products, can be referred to for creation of the drawing for the patent application.

In the case of precision instruments, e.g., engineering products with a fine layout such as an IC chip, an exterior image can be taken with use of a specific microscope (electron microscope); however, such an image is insufficient for a drawing for a patent application. It needs to take time to create a compatible drawing with computer-aided design (CAD) software. In addition, to show the details, a cross-sectional image of the engineering product that is cut out or processed into a thin test piece can be taken as an image used for preparing the drawing. However, also in this case, it takes time to create the compatible drawing with CAD software.

Furthermore, for the drawing for the patent application, CAD software is usually used to create a drawing whose part is subjected to enlargement processing to be different from an actual engineering product to make a characteristic portion of the engineering product emphasized or understandable, by a drawing creator for a patent application. On the assumption that the drawing for the patent application is a schematic diagram, it is created with CAD software experientially or subjectively by the drawing creator, in many cases.

Meanwhile, for a circuit diagram of the engineering product, design data is created by a designer with use of design support software, and verification is conducted with the design data.

In many cases, the design support software is different from the CAD software used by the drawing creator for a patent application.

As described above, conventionally, using different software for creating drawings for patent applications and circuit design is a general technique.

In some foreign countries, a drawing faithful to an actual product is preferred to a drawing processed to have an emphasized portion as a drawing for a patent application.

In view of the above, an object of one embodiment of the present invention is to create a drawing by a drawing creator with use of a generative artificial intelligence (AI) model efficiently using design data created by a circuit designer in producing an engineering product with a fine layout. Note that a drawing obtained with use of the generative AI model is based on a drawing faithful to an actual product.

The circuit designer prepares drawing data faithful to a design value used for the circuit design when the engineering product with a fine layout is produced. Part of the drawing data is enlarged and used for preparing a drawing for a patent application. To the drawing for a patent application, a hatting pattern common to the same material is added for the purpose of clarifying regions and boundaries. The magnifying power of the hatching pattern is lower than 1, which can make it difficult to distinguish hatching patterns when the region is small; the hatching pattern needs to be selected as appropriate.

Examples of engineering products with fine layouts include a display having a fine pixel layout difficult to see with the naked human eye, a sensor having a fine imaging-element layout, and a CPU including a semiconductor circuit with fine wirings and a plurality of semiconductor elements.

According to an embodiment of the present invention, provided is a drawing creation support system assisting a user in creating a drawing for a patent application through the enlargement of a drawing, addition of a hatching pattern, and selection of the hatching pattern with use of a generative AI model (also referred to as a generative model).

A structure of the invention disclosed in this specification is a drawing creation support system as follows: a part of three-dimensional drawing data including design data of a semiconductor circuit is selected on the basis of a user's designated operation; the part is drawing data outputting a two-dimensional cross-sectional view with the same scale as the part; the two-dimensional cross-sectional view includes a plurality of hatched regions; the two-dimensional cross-sectional view is input to a generative AI model that has learned and outputs a magnifying power appropriate to a hatching line in an input drawing; the generative AI model is made to calculate a magnifying power enabling a hatching line spacing to have an optimized width when the hatching line spacing in the hatched region is narrow.

In addition, a drawing that can be fitted in a frame of a drawing for a patent application can be created. Another structure of the invention is a drawing creation support system as follows: a part of three-dimensional drawing data including design data of a semiconductor circuit is selected on the basis of a first designated operation; the part is drawing data outputting a two-dimensional cross-sectional view with the same scale as the part; the two-dimensional cross-sectional view includes a plurality of hatched regions; the two-dimensional cross-sectional view is input to a generative AI model that has learned and outputs a magnifying power appropriate to a hatching line in an input drawing; a generative AI model is made to calculate a magnifying power enabling a hatching line spacing to have an optimized width when the hatching line spacing in the hatched region is narrow; a new two-dimensional drawing data with a size fitted in a frame of a drawing for a patent application is displayed in a display portion of a display device; and the new two-dimensional drawing data is stored on the basis of a second designated operation. The drawing frame (also referred to as a drawing region) on an A4 sized (Letter Size) paper is 170 mm in width by 255 mm length in Japanese patent applications and 170 mm in width by 262 mm in length in PCT international patent applications. The top, bottom, left, and right margins are defined as 25 mm, 10 mm, 25 mm, and 15 mm, respectively.

In each of the above structures, a first position and a second position on the three-dimensional drawing data have distance information relevant to an actual dimension. In other words, a certain coordinate (the first position) and another certain coordinate (the second position) on the three-dimensional drawing data are comparable to a design data dimension; a finished product produced in accordance with the design data dimension has an almost actual dimension.

In each of the above structures, the three-dimensional drawing data is data on which operation check can be performed with use of a circuit verification tool. Note that instead of the three-dimensional drawing data, the data on which operation check can be performed may be a plurality of pieces of two-dimensional drawing data that are cross-sections of the three-dimensional drawing data.

In each of the above structures, the two-dimensional cross-sectional view is a vector image. The vector image is composed of formulae, straight lines, and curves (using points fixed on a grid), and thus can be infinitely enlarged (or shrunk) without a decrease in the definition. The image quality of the vector image is not degraded even when the size of the vector image is changed, which means the vector image has high editability. In the vector image, colors and textures in regions are separately hatched, or hatched textures are added to the regions, whereby the regions can be distinguished and identified.

Design data prepared by a designer of an engineering product with a fine layout can be used for creating a drawing for a patent application, which enables the drawing for a patent application to reflect an actual dimension. Thus, a patent application can be prepared efficiently.

### BRIEF DESCRIPTION OF THE DRAWINGS

FIG. 1 is an exemplified flow chart showing an information processing method.

FIG. 2 is an exemplified flow chart showing an information processing method.

FIG. 3 is a diagram showing information input to an information processing system.

FIG. 4 is a diagram showing a structure of an information processing system.

FIG. 5 is a block diagram showing a structure of an information processing system.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, the terms “first” and “second” are sometimes used for easy understanding of the technical contents or identification of components. Thus, the terms “first” and “second” do not limit the number of components. In addition, the terms “first” and “second” do not limit the order of components. In addition, the terms such as “first” and “second” or identification numerals used in this specification do not correspond to the terms or the identification numerals in the scope of claims of this application in some cases.

### Embodiment 1

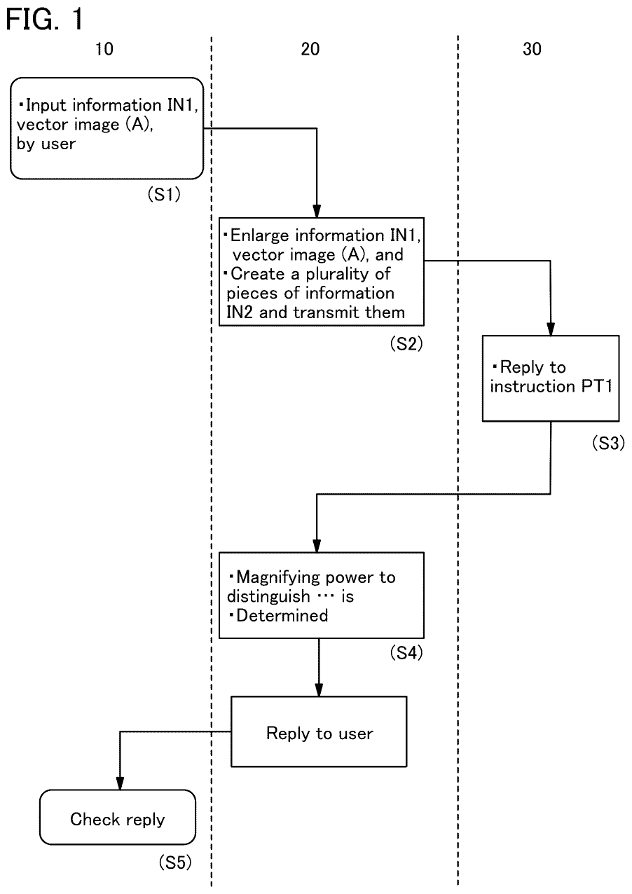

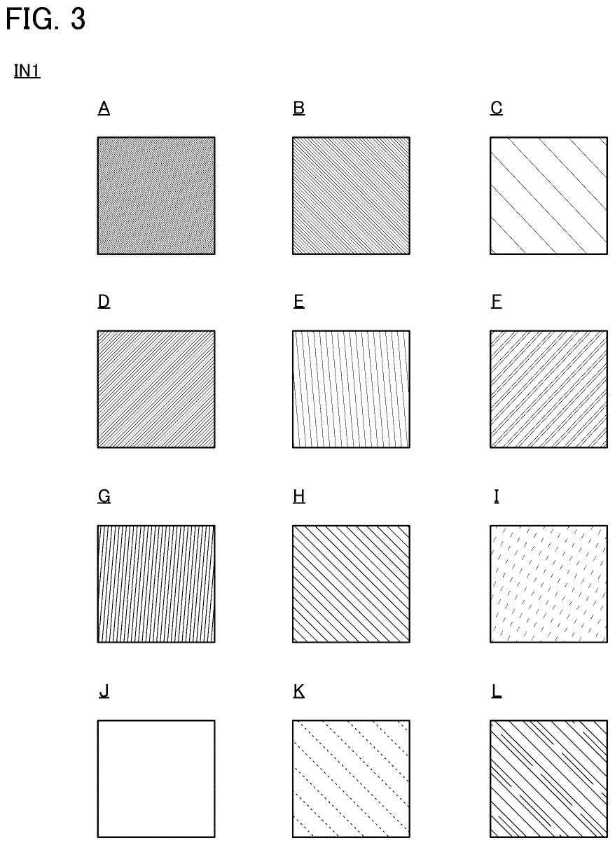

In this embodiment, an information processing method of one embodiment of the present invention will be described with reference to FIG. 1 and FIG. 3.

FIG. 1 is a diagram showing an information processing method of one embodiment of the present invention. The information processing system of one embodiment of the present invention includes a component 10, a component 20, and a component 30. As the component 10, a desktop computer to which a user inputs information or which enables the user to see the information on a display portion is used, for example. As the display portion, a display device such as a liquid crystal display device, a light-emitting device (e.g., a light emitting-device in which a light-emitting element such as an organic EL element is provided in each pixel), an electrophoresis display device, a digital micromirror device (DMD), a plasma display panel (PDP), or a field emission display (FED) can be used, for example. As the component 20, a workstation, a server computer, or a supercomputer can be used, for example. As the component 30, a large computer such as a server computer or a supercomputer can be used, for example. Note that the component 30 has a larger scale and higher computational capability than the component 20. The component 30 may have a function of performing processing using a generative AI model incorporating a graph neural network (GNN). With use of the generative AI model incorporating a GNN, learning, inference, or the like for image data in a vector format, such as patent drawings, can be effectively performed. Typical examples of the model using a GNN include a graph convolutional network (GCN) and a GraphSAGE3. In addition, an image in a raster format (raster image) can be used. A GNN is not always necessary for the component 30 when a raster image is used. The raster image is expressed with an aggregate of a plurality of “pixels”, whereas the vector image is expressed with a plurality of “points” and “lines” connecting the points.

First, two-dimensional drawing data (a two-dimensional cross-sectional view of a semiconductor substrate) prepared in advance is used. For clarity, a hatching pattern is used for a predetermined portion in the two-dimensional drawing data. The two-dimensional drawing data is a vector image. A vector image can be referred to as an image in a vector format. The two-dimensional drawing data is preferably in a state of having been converted on the basis of data (e.g., three-dimensional drawing) used in design support software (e.g., Process Explorer) for manufacturing semiconductor devices including semiconductor circuits and the like, in which case two-dimensional drawing data is efficiently created.

Since data (e.g., three-dimensional drawing data) used in the design support software is data that faithfully reproduces, in advance, numerical values of the actual dimension of a product to be produced, distance information relevant to the actual dimension is included in the data. It is preferable that the data be available for verification processing with verification software of a semiconductor circuit (operation check with use of a commercially available circuit verification tool).

In the component 10, information IN1 that is a prepared vector image (A) is input to a drawing creation support system in accordance with a first designated operation by the user (S1: Step 1). Each region in the input vector image (A) that is two-dimensional drawing data is hatched by the drawing creation support system.

The information IN1 includes image data displaying a list of hatching patterns. FIG. 3 shows image data displaying a hatching pattern list (including 12 kinds of hatching patterns A to L) as an example of information included in the information IN1. Note that the list shown here is just an example, and the hatching patterns are not limited to 12 kinds of hatching patterns. The hatching patterns included in the list may be less than 12 kinds of hatching patterns or more than or equal to 13 kinds of hatching patterns. The hatching pattern is composed of one or more hatching lines, and a plurality of hatching lines are arranged at regular spacing.

Furthermore, it is possible to obtain the vector image (A) showing a region B framed by a dotted line designated by the user, in which case the region B indicates a region to be enlarged. In this embodiment, an example in which one figure is drawn to include two diagrams is described. One vector image (A) is prepared and placed by the user. The other diagram corresponds to the region B (a portion selected by the user) that is to be enlarged in the vector image (A).

Next, with a vector image editing application incorporated in the drawing creation support system, the region B included in the vector image (A) is enlarged in the component 20. A plurality of pieces of information IN2 split by the magnification condition of the region B in the vector image (A), i.e., vector images (B1) to (Bn (n is an integer greater than or equal to 2)) showing the enlarged region B, are generated. The magnifying power is set in advance for the vector images (B1) to (Bn). The magnifying power that is ×1 is called the same scale, and the magnifying power includes the same scale. The magnifying power that is less than ×1 can be referred to as scale-down but is included in a category of magnifying power.

Next, the drawing creation support system transmits the vector images (B1) to (Bn) and an instruction PT1 as prompts to the component 30 (S2: Step 2). An example of the instruction PT1 is “Show me which images whose hatching patterns at certain regions can be distinguished are among the attached images.” The component 30 has a function of performing processing on the input instruction with the generative AI model. Note that the generative AI model is a learned generative AI model that outputs a magnifying power appropriate to the hatching line spacing in the input drawing. In this structure, the instruction PT1 does not use the wording “Show me the magnifying power of the hatching patterns that can be distinguished at certain regions in the attached images.”, because of the following reasons. If the wording is used in the instruction PT1, the hatching pattern with a magnification changed as appropriate is provided to the user. However, the user may have the hatching patterns linked to colors and names, in which case the number of hatching patterns managed by the user increases unlimitedly by repeated use of the above system, and it becomes difficult to manage the hatching patterns.

Incidentally, “the hatching patterns can be distinguished” indicates that a hatching pattern given to a certain region can be discerned from another hatching pattern. In the case where the region area is smaller than the hatching line spacing depending on the hatching pattern or the case where the boundary of the region is parallel to the hatching line, it is regarded as impossible to distinguish the hatching patterns. Since the thickness of a line that can be used for the drawing for a patent application is specified, it is determined whether or not the hatching pattern can be distinguished when the thickness of the line is made larger than the specified thickness. For example, the human eye is not capable of recognizing a pattern printed with approximately 300 dots per inch (dpi) or higher. When the hatching pattern has a hatching line spacing with 300 dpi or higher, which cannot be recognized by the human eye, whether or not the hatching pattern can be employed for a drawing is determined in the following manner: a surrounding drawing area of the hatching pattern is filled in black, and whether or not the hatching pattern in one region can be discerned from another hatching pattern is checked. If the hatching pattern on the one region can be distinguished, it is available.

Next, the component 30 gives the component 20 a reply to the instruction PT1 (S3: Step 3).

Then, the drawing creation support system gains a distinguishable image output to the component 20 from the generative AI in the component 30 and thus has information IN3, specifically the minimum value of the magnifying power, obtained from the above steps. In this manner, the optimal magnifying power of the drawing is determined (S4: Step 4).

In some cases, the resolution is specified by Patent Offices depending on countries other than Japan. For example, the maximum allowable drawing resolution in PCT electronic application software is 400 dpi. Meanwhile, according to the U.S. Patent and Trademark Office and the China National Intellectual Property Administration, the maximum resolution is specified to 300 dpi. Thus, it is preferable to add an instruction to consider the resolution specified by the Patent Office in the country where the user is going to file a patent application, whereby the minimum value of the magnifying power is calculated.

Next, the drawing creation support system makes a suggestion to the user about arrangement of the vector image (A) and a new vector image (B) enlarged at a magnifying power that is higher than or equal to the above minimum value, that is, at an optimal magnifying power within a range of a predetermined format, displaying the images in the display portion of the display device. The user can check the suggested drawing (image) as the reply in a display portion of the component 10 and store the suggested drawing (image) in accordance with a second designated operation by the user (S5: Step 5). The storage place may be the component 10 or the component 20.

Through the above procedure, a drawing the user desires for a patent application, specifically, one drawing where the vector image (A) and the vector image (B) obtained by enlarging the region B are arranged, can be prepared in a short time.

This embodiment can be freely combined with any of the other embodiments.

### Embodiment 2

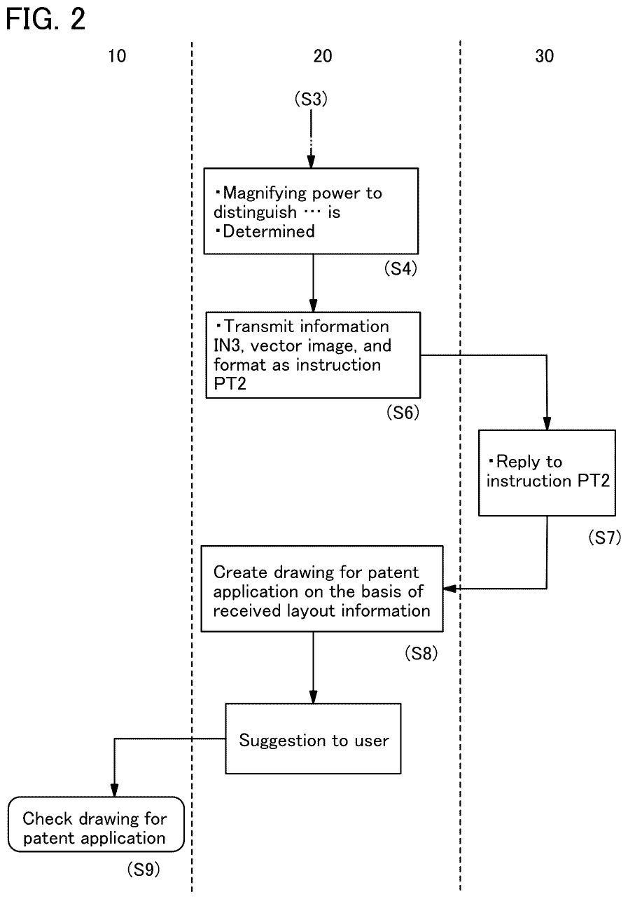

In this embodiment, an information processing method of one embodiment of the present invention will be described with reference to FIG. 2.

The processing in this embodiment has the same steps up to Step 3 (S3) as those in Embodiment 1; thus the detailed description of the steps is skipped.

Note that for reference numerals used in the following description that are the same as those used in Embodiment 1, the description in Embodiment 1 can be applied to. Thus, detailed description of the meaning, definition, and the like of a component denoted by such a reference numeral is omitted below in some cases.

This embodiment shows an example in which a plurality of cross-sectional structure diagrams (two-dimensional cross-sectional views) are arranged in one drawing. Specifically, three figures in total, the vector image (A), the vector image (B) enlarged at a magnifying power that is higher than or equal to the minimum value, and a vector image (C) are arranged within a range of a predetermined format. The vector image (B) corresponds to a diagram obtained by enlarging the region B in the vector image (A), and the vector image (C) corresponds to a diagram obtained by enlarging a region C in the vector image (A).

In a manner similar to the generation of the images (B1) to (Bn) in Embodiment 1, vector images (C1) to (Cn) are generated, and an instruction PT2 is set as follow: “Show me an arrangement so that the attached vector image (A), one of the attached vector images (Bm) to (Bn), and one of the attached vector image (Cm) to (Cn) are placed at intervals as equal as possible within a specified format. In the case where the format fails to include any of the images given above, add the same type of format and place the image having failed to be included. In the case where the format can include the images given above, select the images as large as possible from the vector images (Bm) to (Bn) and the vector images (Cm) to (Cn).” The instruction PT2 and each of the vector images are transmitted as prompts to the generative AI model in the component 30 (S6: Step 6). Note that 1<m<n.

The generative AI model provided in the component 30 preferably includes a GNN that is a graph neural network and is, for example, suitable for solving a problem to a figure in a vector image. For example, a positional relation between a region with a hatching pattern (also referred to as a hatched region) and its adjacent region may be grasped, and there is a possibility of solving the problem effectively.

Accordingly, the drawing creation support system obtains the information IN3 for arranging the vector image (A), the vector image (B) showing the enlarged region B, and the vector image (C) showing the enlarged region C within a format, with use of the generative AI model. Examples of the information IN3 include the magnifying power and the layout coordinates. The information IN3 is given as a reply to the instruction PT2 to the component 20 (S7: Step 7). In the component 20, a drawing for a patent application (new two-dimensional cross-sectional view) is created on the basis of the layout information included in the received information IN3 (S8: Step 8).

The drawing creation support system makes a suggestion of the drawing for a patent application (new two-dimensional cross-sectional view) through the component 10 for the user.

The suggested drawing is fitted within a predetermined frame of a drawing for a patent application. The user checks the suggested drawing for a patent application, which is displayed in the display portion of the component 10 (S9: Step 9). After the check, the user can store the suggested drawing (image) in accordance with the second designated operation by the user. The place for storing the drawing (image) may be the component 10 or the component 20. Through the above procedure, a drawing the user desired for a patent application, specifically, one drawing in which the vector image (A), the vector image (B), and the vector image (C) are placed can be prepared in a short time.

Although this embodiment shows the example of three vector images included in one drawing, one embodiment of the present invention is not particularly limited to the example and can be applied to a case where four or more vector images are placed in one drawing.

Furthermore, after the vector images (Bm) to (Bn) and the vector images (Cm) to (Cn) are created, the FFT spatial frequency of each hatching pattern may be obtained so that whether the diameter of each region is n times as large as the wavelength is included in the prompt as supplementary data.

This embodiment can be freely combined with Embodiment 1.

### Embodiment 3

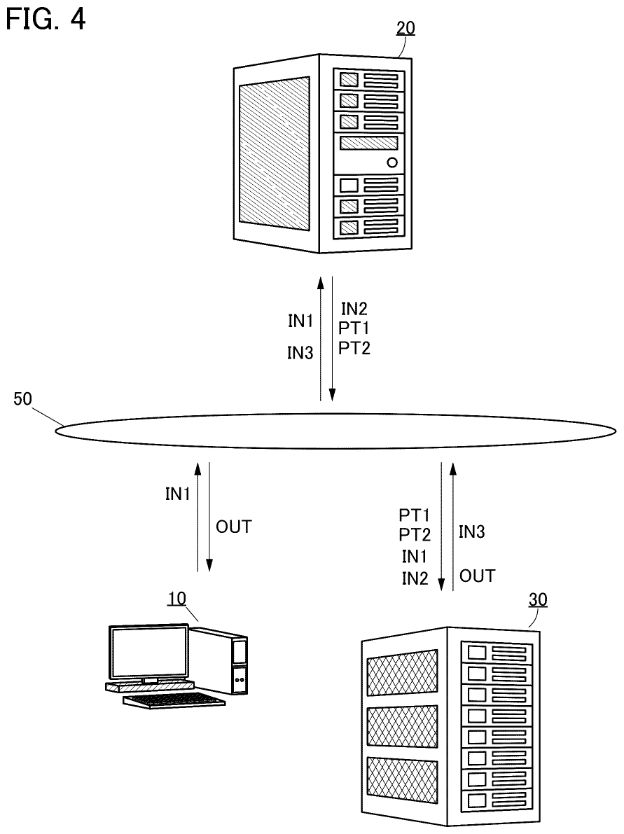

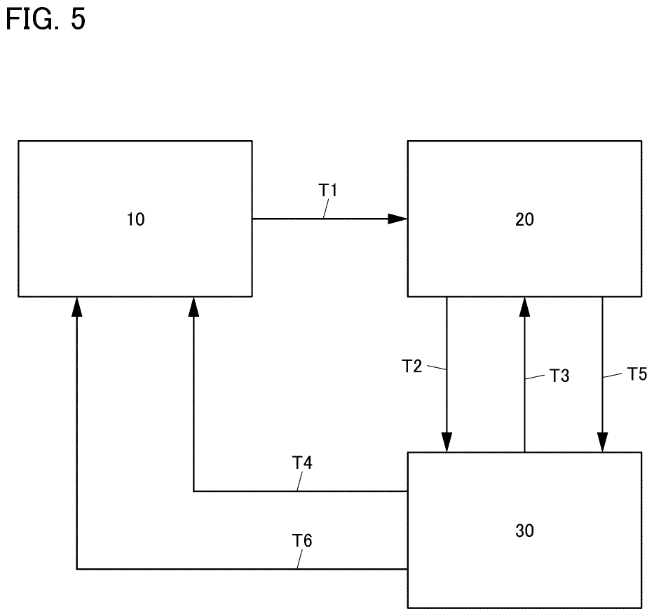

In this embodiment, an information processing system of one embodiment of the present invention will be described with reference to FIG. 4 and FIG. 5.

### <Structure Example of Information Processing System>

FIG. 4 illustrates structure examples of constituent elements of the information processing system of one embodiment of the present invention, and a network connecting these constituent elements. An example of a flow of data that is transmitted between the constituent elements of the information processing system will be described.

FIG. 5 illustrates a more detailed example of the flow of data that is transmitted between the constituent elements of the information processing system illustrated in FIG. 4.

Although FIG. 4 and FIG. 5 each illustrate constituent elements classified by their functions in independent components or blocks, it is difficult to classify actual constituent elements completely on the basis of their functions, and one constituent element can have a plurality of functions.

As illustrated in FIG. 4, the information processing system of one embodiment of the present invention includes the component 10, the component 20, and the component 30. The information processing system transmits predetermined data between the above components through a network 50.

The functions of the information processing system of one embodiment of the present invention will be described separately below on the component basis with reference to FIG. 4 and FIG. 5. Note that the description of the data transmission between the components is partly repeated in some cases.

### «Structure Example of Component 10»

The component 10 can receive data input by the user. The component 10 provides at least an environment enabling the user to use an image editing application (e.g., Vectorworks (registered trademark)) in advance. Furthermore, the component 10 can display data output by the component 20 in the display portion and present the data to the user.

Dedicated application software or a web browser operates, for example. Via any of them, the user can access the information processing system. Thus, the user can receive service using the information processing system of one embodiment of the present invention.

In processing T1 indicated by an arrow in FIG. 5, the component 10 has a function of receiving information (the information IN1 illustrated in FIG. 4) input by the user and transferring the information to the component 20. The information IN1 is vector image data.

The description below is for a case of utilizing the information processing system of one embodiment of the present invention for the purpose of creating a drawing where a vector image and another vector image that is part of the vector image enlarged at an appropriate magnifying power are arranged. However, one embodiment of the present invention is not limited to this case, and the information processing system can be utilized for various cases.

The information IN1 is vector image data including a large amount of design information. The design information includes wiring widths (line thicknesses), layout information including three-dimensional data, hatching pattern information (e.g., the kind of hatching lines and hatching line spacing), and material information.

The information IN2 is a plurality of pieces of vector image data prepared in the component 20 and split by the magnification condition for regions in the vector image. The vector image is only enlarged in the component 20. Thus, the component 20 does not have to provide an environment enabling use of an image editing application (e.g., Vectorworks) or can have another image editing application different from that in the component 10.

The information IN3 is text data with a minimum value of a magnifying power calculated from the plurality of pieces of vector image data input as the information IN2.

In processing T4 indicated by an arrow in FIG. 5, the component 10 has a function of receiving information (the information IN3 illustrated in FIG. 4) created by the component 30 and providing the information to the user. Note that the details of the information IN3 are described above.

In processing T6 indicated by an arrow in FIG. 5, the component 10 has a function of receiving information (information OUT illustrated in FIG. 4) generated by the component 30. The details of the information OUT are described in «Structure example of component 20» below.

### «Structure Example of Component 20»

The component 20 preferably has a function of a parallel computer. When the component 20 is used as a parallel computer, large-scale computation necessary for AI learning and inference can be performed, for example.

The component 20 can perform processing using a natural language processing model using an AI model.

For example, it is possible to execute processing using a natural language model (natural language processing) such as Bidirectional Encoder Representations from Transformers (BERT), Text-to-Text Transfer Transformer (T5), GPT-3 (registered trademark), GPT-3.5 (registered trademark), GPT-4 (registered trademark), Language Model for Dialogue Applications (LaMDA), Pathways Language Model (PaLM), or Llama2.

In the processing T1 indicated by the arrow in FIG. 5, the component 20 has a function of receiving the information IN1 transferred from the component 10.

The component 20 has a function of transferring the instruction PT1 or the instruction PT2 to the component 30. The instruction PT1 or the instruction PT2 is a sentence that includes instructions using the information IN1 transferred from the component 10 and is transferred to the component 30.

In the instruction PT1 or the instruction PT2, specific processing details executed by the component 30 are written in a natural language. An example of the instruction PT1 is an instruction “Show me which images whose hatching patterns at certain regions can be distinguished are among attached images.”

The component 20 can also have a function of generating the instruction PT1 automatically in accordance with the contents of the information IN1 or the information IN2.

An example of the instruction PT2 is an instruction “Show me an arrangement so that the attached vector image (A), one of the attached vector images (Bm) to (Bn), and one of the attached vector images (Cm) to (Cn) are placed at intervals as equal as possible within a specified format. In the case where the format fails to include any of the images given above, add the same type of format and place the image having failed to be included. In the case where the format can include the images given above, select the images as large as possible from the vector images (Bm) to (Bn) and the vector images (Cm) to (Cn).” One instruction may be divided into a first instruction and a second instruction. The second instruction is a sentence written as an additional condition of the first instruction. As the additional condition, two or more sentences may be used. The number of sentences written as the instruction PT2 can be increased depending on the number of conditions demanded by the user.

In processing T2 indicated by an arrow in FIG. 5, the component 20 has a function of transferring the instruction PT1 and the above image data to the component 30 and making the component 30 execute the instructions written in the instruction PT1.

In processing T5 indicated by an arrow in FIG. 5, the component 20 has a function of transferring the instruction PT2 to the component 30 and making the component 30 execute the instructions written in the instruction PT2.

The information OUT output from the component 30, which is illustrated in FIG. 4, may include information of a cause of difficulty in the processing in the component 30, specifically, a cause of a case where the information is insufficient for the processing in the component 30 or where a calculation result cannot be obtained from the processing in the component 30. Although not illustrated in FIG. 4, the component 20 can also have a function of receiving the information OUT generated by the component 30. Furthermore, the component 20 can have a function of creating a script suiting the image editing application such as Vectorworks described above on the basis of the information OUT and transferring the script to the component 10.

### «Structure Example of Component 30»

As the component 30, a large computer such as a server computer or a supercomputer can be used, for example. Note that the component 30 has a larger scale and higher computational capability than the component 20.

The component 30 preferably has a function of a parallel computer. When the component 30 is used as a parallel computer, large-scale computation necessary for learning and inference of an AI model can be performed, for example.

The component 30 processes text and an image such as hatching. The component 30 can be a multimodal model or a foundation model that handles images and text.

For example, when a foundation model such as CLIP, DALL-E, Flamingo, United-IO, Gato, Imagen, or Parti is used, an image and text can be processed.

When receiving a raster image, the component 30 performs processing with an AI model. When receiving a vector image, the component 30 may have a function of performing processing with an AI model incorporating a GNN. With use of an AI model incorporating a GNN, learning, inference, or the like for image data (in a vector format) for a drawing for a patent application or the like can be performed. Typical examples of the model using a GNN include GCN and GraphSAGE3.

Note that a provider that provides service with use of the information processing system of one embodiment of the present invention does not necessarily have to own the component 30. For example, the service provider can use part of the service which another company or the like provides as the component 30.

In this manner, the component 30 can execute the instructions in the instruction PT1 or the instruction PT2 by performing processing using a model that handles images and text.

In the processing T6 indicated by the arrow in FIG. 5, the component 30 has a function of transferring the information OUT to the component 10.

The component 30 has a function of performing processing with use of a large language model (which is different from the large language model that can be included in the component 20). Note that the large language model has learned a data set. Thus, on the basis of the information IN1, the information IN2, the instruction PT1, and the instruction PT2 transferred from the component 20, the component 30 can determine whether or not the information IN1 and the information IN2 are sufficient as input contents.

The information processing system of one embodiment of the present invention, which has various functions as described above, enables easy creation of a drawing (e.g., a drawing where regions are distinguished with appropriate hatching patterns for visibility) for a patent application, that looks good, for which the user only has to give necessary information to the information processing system, independently from the user's sense, skill, and the like. As a result, a new information processing system with high convenience can be provided.

The information processing system of one embodiment of the present invention includes an information processing device having the functions of the above-described components.

When the information processing system of one embodiment of the present invention is composed of a plurality of information processing devices, loads related to information processing can be split.

This application is based on Japanese Patent Application Serial No. 2024-070347 filed with Japan Patent Office on Apr. 24, 2024, the entire contents of which are hereby incorporated by reference.

What is claimed is:

1. A drawing creation support system comprising:
selecting a part of three-dimensional drawing data comprising design data of a semiconductor circuit on the basis of a user's operation;
outputting the part of the three-dimensional drawing data as a two-dimensional cross-sectional view with the same scale as the part of the three-dimensional drawing data;
inputting the two-dimensional cross-sectional view to a generative AI model that outputs a magnifying power appropriate to a hatching line in an input drawing; and
making the generative AI model calculate a magnifying power enabling a hatching line spacing to have an optimized width when the hatching line spacing in a hatched region of the two-dimensional cross-sectional view is narrow.

2. The drawing creation support system according to claim 1, wherein a first position and a second position on the three-dimensional drawing data comprises distance information relevant to an actual dimension.

3. The drawing creation support system according to claim 1, wherein the three-dimensional drawing data is data on which operation check is performed with use of a circuit verification tool.

4. The drawing creation support system according to claim 1, wherein the two-dimensional cross-sectional view is a vector image.

5. A drawing creation support system comprising:
selecting a part of three-dimensional drawing data comprising design data of a semiconductor circuit on the basis of a first operation;
outputting the part of the three-dimensional drawing data as a first two-dimensional cross-sectional view with the same scale as the part of the three-dimensional drawing data;
inputting the first two-dimensional cross-sectional view to a generative AI model that outputs a magnifying power appropriate to a hatching line in an input drawing;
making the generative AI model calculate a magnifying power enabling a hatching line spacing to have an optimized width when the hatching line spacing in a hatched region of the first two-dimensional cross-sectional view is narrow;
displaying a second two-dimensional cross-sectional view with a size fitted in a frame of a drawing for a patent application in a display portion of a display device; and
storing the second two-dimensional cross-sectional view on the basis of a second operation.

6. The drawing creation support system according to claim 5, wherein a first position and a second position on the three-dimensional drawing data comprises distance information relevant to an actual dimension.

7. The drawing creation support system according to claim 5, wherein the three-dimensional drawing data is data on which operation check is performed with use of a circuit verification tool.

8. The drawing creation support system according to claim 5, wherein each of the first two-dimensional cross-sectional view and the second two-dimensional cross-sectional view is a vector image.
